(19) United States
(12) Patent Application Publication
(10) Pub. No.: US 2009/0210866 A1
(43) Pub. Date: Aug. 20, 2009

(54) METHODS, SYSTEMS, AND COMPUTER PROGRAM PRODUCTS FOR UPDATING SOFTWARE ON A DATA PROCESSING SYSTEM BASED ON TRANSITION RULES BETWEEN CLASSES OF COMPATIBLE VERSIONS

(75) Inventor: Erik Troan, Cary, NC (US)

Correspondence Address: MYERS BIGEL SIBLEY & SAJOVEC, PO BOX 37428, RALEIGH, NC, 27627, US

(73) Assignee: rPath, Inc.

(21) Appl. No.: 12/032,827

(22) Filed: Feb. 18, 2008

(51) Int. Cl. G06F 9/44

(52) U.S. Cl. 717/168

(57) ABSTRACT

Software is updated by defining a plurality of compatibility classes for software versions, generating rules for transitions between ones of the plurality of compatibility classes, and updating software from a first one of the software versions to a second one of the software versions based on the rules.

### BACKGROUND OF THE INVENTION

The present invention relates to data processing methods, systems, and computer program products, and, more particularly, to data processing methods, systems, and computer program products for updating software on a data processing system.

A technique known as software versioning is often used to keep track of different instances of a software product. For example, a software provider may assign different release names or numbers to a particular software product to identify the sequence and content of the different versions of the product. While a software product is being developed, the developers may assign version numbers to the product at various stages of development to mark, for example, milestones where significant changes in content or functionality have been added to the product. The version labeling or numbering system may be relatively simple and only identify major milestones in functionality or content or may be more complex and use multiple fields to identify more substantial changes in content along with more minor changes, such as the addition of minor features, patches, etc.

A software developer or customer may desire to transition from one software version to another. Conventional software management and/or development systems generally rely on versioning information to determine how to transition from one software version to another. Unfortunately, conventional versioning systems generally do not provide sufficient rules for transitioning between software versions, particularly where there may be numerous versions of a software product publicly available with a variety of paths that may be used for transitioning between the available versions.

### BRIEF SUMMARY OF THE INVENTION

According to some embodiments of the present invention, software may be updated by defining a plurality of compatibility classes for software versions, generating rules for transitions between ones of the plurality of compatibility classes, and updating software from a first one of the software versions to a second one of the software versions based on the rules.

In other embodiments, the first one of the software versions is in a first one of the plurality of compatibility classes and the second one of the software versions is in a second one of the compatibility classes. The rules include at least one rule that disallows a transition from the second one of the plurality of compatibility classes to the first one of the plurality of compatibility classes.

In further embodiments, the first one of the software versions is in a first one of the plurality of compatibility classes and the second one of the software versions is in a second one of the compatibility classes. Updating the software includes updating the software from the first one of the software versions to the second one of the software versions based on at least a first one of the rules for transitioning directly from the first one of the plurality of compatibility classes to the second one of the plurality of compatibility classes.

In still further embodiments, the rules include a second one of the rules that disallows a transition directly from the second one of the plurality of compatibility classes to the first one of the plurality of compatibility classes.

In still further embodiments, the rules include a second one of the rules for transitioning from the first one of the plurality of compatibility classes to a third one of the plurality of compatibility classes and a third one of the rules for transitioning from the third one of the plurality of compatibility classes to the second one of the plurality of compatibility classes.

In still further embodiments, the rules include a fourth one of the rules that disallows a transition from the second one of the plurality of compatibility classes to the third one of the plurality of compatibility classes or a transition from the third one of the plurality of compatibility classes to the first one of the plurality of compatibility classes.

In other embodiments, the first one of the software versions is in a first one of the plurality of compatibility classes and the second one of the software versions is in a second one of the plurality of compatibility classes. Updating the software includes updating the software from the first one of the software versions to the second one of the software versions based on at least a first one of the rules for transitioning from the first one of the plurality of compatibility classes to a third one of the plurality of compatibility classes and a second one of the rules for transitioning from the third one of the plurality of compatibility classes to the second one of the plurality of compatibility classes.

In still other embodiments, the rules include a third one of the rules for transitioning directly from the first one of the plurality of compatibility classes to the second one of the plurality of compatibility classes.

In still other embodiments, the rules include a third one of the rules that disallows a transition from the second one of the plurality of compatibility classes to the third one of the plurality of compatibility classes or a transition from the third one of the plurality of compatibility classes to the first one of the plurality of compatibility classes.

In still other embodiments, the rules include a third one of the rules that disallows a transition directly from the second one of the plurality of compatibility classes to the first one of the plurality of compatibility classes.

In still other embodiments, the rules include a third one of the rules that disallows a transition directly from the first one of the plurality of compatibility classes to the second one of the plurality of compatibility classes

In further embodiments, one of the compatibility classes has a plurality of the software versions associated therewith.

In still further embodiments, one of the compatibility classes has only one of the software versions associated therewith.

Although described primarily above with respect to method aspects of the present invention, it will be understood that the present invention may also be embodied as systems and computer program products.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a software development environment in accordance with some embodiments of the present invention;

FIG. 2 is a data processing system for use in the software development environment of FIG. 1 in accordance with some embodiments of the present invention;

FIG. 3 is a block diagram that illustrates a software/hardware architecture for updating software based on transition rules between compatible versions in accordance with some embodiments of the present invention;

FIG. 4 is a block diagram that illustrates rules for transitioning between software versions in accordance with some embodiments of the present invention;

FIG. 5 is a matrix that illustrates rules for transitioning between compatibility classes of software versions in accordance with some embodiments of the present invention; and

FIG. 6 is a flowchart that illustrates operations for updating software based on transition rules between compatible versions in accordance with some embodiments of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “file” may include any construct that binds a conglomeration of information, such as instructions, numbers, words, and/or images into a coherent unit. Accordingly, a file may be, for example, a document, an image, an email, a database document (e.g., a Lotus Notes document), an application (e.g., a Powerpoint presentation), and/or a Web page.

Some embodiments of the present invention may arise from a realization that conventional software management and/or development systems generally do not provide sufficient rules for transitioning between software versions. It may be desirable, therefore, to provide a mechanism that allows software developers and/or system administrators to determine how to transition between software versions. In some embodiments, one or more compatibility classes are defined with each class encompassing all software versions that are equivalent in terms of changes involved in transitioning between classes. Rules can be defined for transitioning between the classes. For example, the rules may define what elements are added, what elements are removed, and what modifications are made to one or more of the elements when transitioning from one of the compatibility classes to another. This may allow a software update operation to occur by applying the rules for transitioning from a software version in one compatibility class to a software version in another compatibility class. By using transition rules, invalid transitions, which may be called rollback fences, may be readily defined. This may allow a software developer to know in advance that if a software update is made to transition to a software version in a certain compatibility class, then it may not be possible to rollback to a version in another, e.g., previous, compatibility class. Moreover, the transition rules may also allow for the automation of updates by defining a valid update transition path.

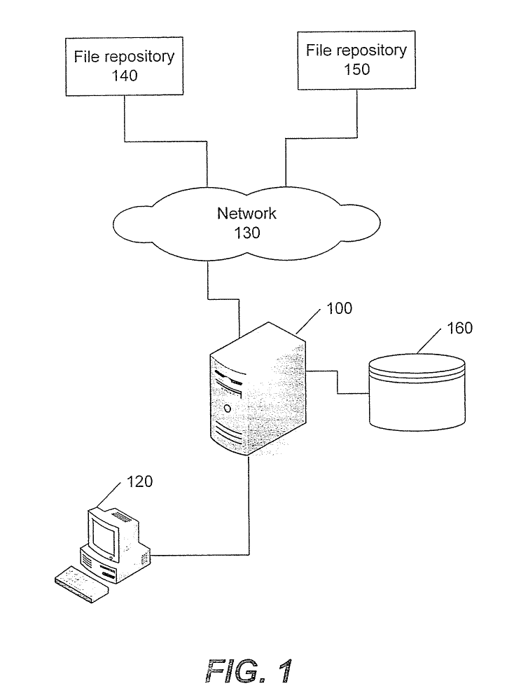

Referring to FIG. 1, a software development environment, in accordance with some embodiments of the present invention, comprises a development server 100 that is coupled to a client workstation 120, a network 130, and a storage system 160. The network 130 may be a global network, such as the Internet or other publicly accessible network. Various elements of the network may be interconnected by a wide area network, a local area network, an Intranet, and/or other private network, which may not be accessible by the general public. Thus, the communication network 130 may represent a combination of public and private networks or a virtual private network (VPN). One or more software developers may use workstations, such as workstation 120, to develop software on the development server 100. This software may run on the development server 100 and may also be stored thereon and/or on the storage system 160. The storage system 160 may also be used to store backups/snapshots of the data processing system 100 software, versions of various software files/components, libraries, development tools, and/or other files use in the development process. In some embodiments, various software files, such as applications, open source components, data, etc., may be obtained from other sources, such as file repositories 140 and 150. Thus, a software developer may write new code and/or incorporate existing modules developed by others into the software being developed on the development server 100. Although two repositories and one workstation client are shown in FIG. 1, it will be understood that fewer or additional repositories and/or clients may be used in accordance with various embodiments of the present invention. It will be appreciated that the development server 100 may be implemented as a single server, separate servers, or a network of servers either co-located in a server farm, for example, or located in different geographic regions.

As shown in FIG. 1, some embodiments according to the invention can operate in a logically separated client side/server side-computing environment, sometimes referred to hereinafter as a client/server environment. The client/server environment is a computational architecture that involves a client process (i.e., client workstation 120) requesting service from a server process (i.e., development server 100, and file depositories 140 and 150). In general, the client/server environment maintains a distinction between processes, although client and server processes may operate on different machines or on the same machine. Accordingly, the client and server sides of the client/server environment are referred to as being logically separated. Usually, when client and server processes operate on separate devices, each device can be customized for the needs of the respective process. For example, a server process can “run on” a system having large amounts of memory and disk space, whereas the client process often “runs on” a system having a graphic user interface provided by high-end video cards and large-screen displays.

The clients and servers can communicate using a standard communications mode, such as Hypertext Transport Protocol (HTTP), SOAP, and/or XML-RPC. According to the HTTP request- response communications model, HTTP requests are sent from the client to the server and HTTP responses are sent from the server to the client in response to an HTTP request. In operation, the server waits for a client to open a connection and to request information, such as a Web page. In response, the server sends a copy of the requested information to the client, closes the connection to the client, and waits for the next connection. It will be understood that the server can respond to requests from more than one client.

Although FIG. 1 illustrates an exemplary software development environment, it will be understood that the present invention is not limited to such configurations, but is intended to encompass any configuration capable of carrying out the operations described herein. For example, for purposes of illustration, some embodiments of the present invention are described herein in the context of a software development environment. Various embodiments of the present invention may also be applicable to the management of software on a data processing system, including, for example, updates and/or other revisions to the system software.

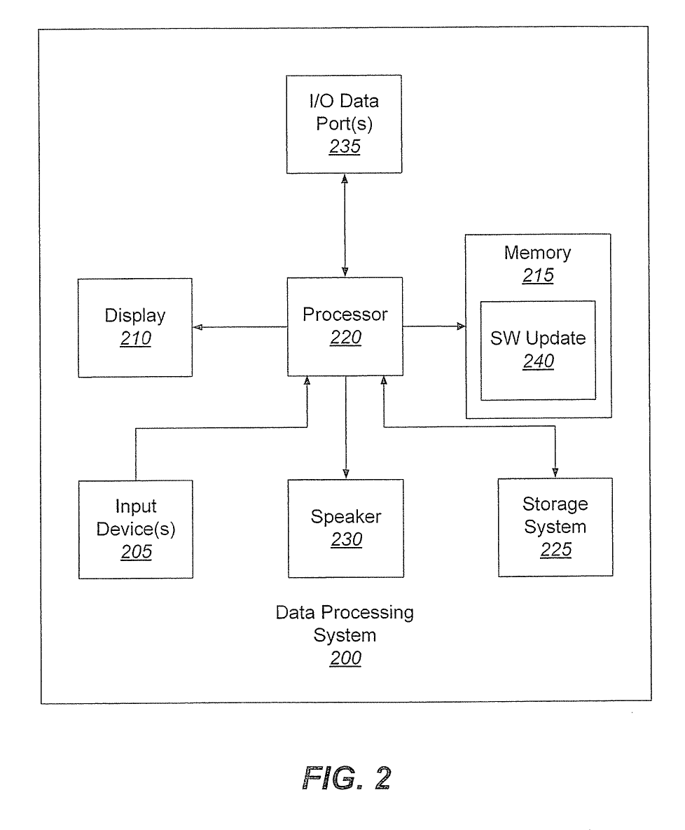

FIG. 2 illustrates a data processing system 200 that may be used to implement the development server 100 of FIG. 1 and that may include a module for updating software on a data processing system in accordance with some embodiments of the present invention. The data processing system 200 comprises input device(s) 205, such as a keyboard or keypad, a display 210, and a memory 215 that communicate with a processor 220. The data processing system 200 may further comprise a storage system 225, a speaker 230, and an I/O data port(s) 235 that also communicate with the processor 220. The storage system 225 may include removable and/or fixed media, such as floppy disks, ZIP drives, hard disks, or the like as well as virtual storage such as a RAMDISK. The I/O data port(s) 235 may be used to transfer information between the data processing system 100 and another computer system or a network (e.g., the Internet). These components may be conventional components, such as those used in many conventional computing devices, and their functionality, with respect to conventional operations, is generally known to those skilled in the art. The memory 215 may be configured with a software update module 240 that may be used to update software on the data processing system 200. The type of update made to the software is not limited and may be made in a variety of forms. For example, an entire application or operating system may be updated, a portion of a software product may be updated through the addition or subtraction of a feature module, a software product under development may be updated through the addition of new functionality and/or bug fixes/patches, a software product may be rebuilt after acquiring updated versions of various files that comprise the software product, and/or a software product may be updated through the use of new data, e.g., updating a database with new data, etc. These non-limiting examples are for purposes of illustrating various embodiments of the present invention and are not exhaustive of the types of software updates that can be performed.

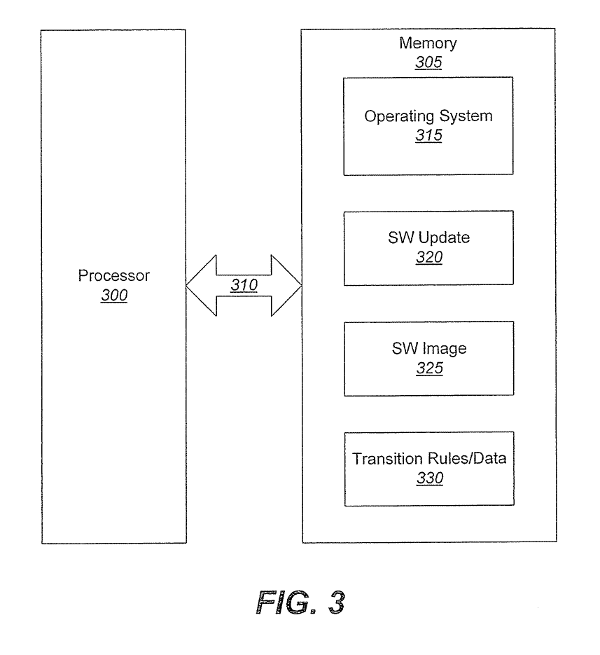

FIG. 3 illustrates a processor 300 and memory 305 that may be used in embodiments of data processing systems, such as the development server 100 of FIG. 1 and/or the data processing system 200 of FIG. 2, in which software is updated based on transition rules between compatible versions in accordance with some embodiments of the present invention. The processor 300 communicates with the memory 305 via an address/data bus 310. The processor 300 may be, for example, a commercially available or custom microprocessor. The memory 305 is representative of the one or more memory devices containing the software and data used adaptive, context based file selection in accordance with some embodiments of the present invention. The memory 305 may include, but is not limited to, the following types of devices: cache, ROM, PROM, EPROM, EEPROM, flash, SRAM, and DRAM.

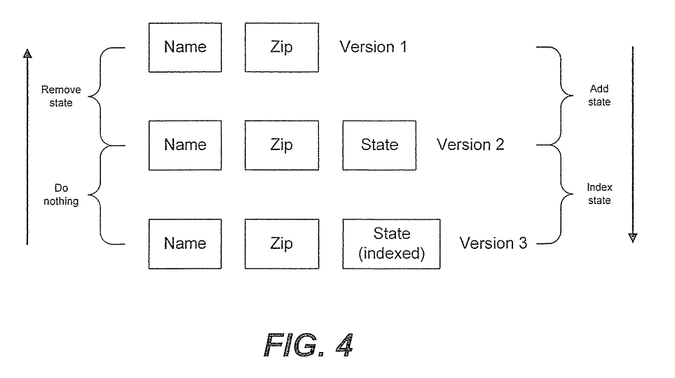

As shown in FIG. 3, the memory 305 may contain up to four or more categories of software and/or data: the operating system 315, a software update module 320, a software image 325, and a transition rules/data module 330. The operating system 315 generally controls the operation of the data processing system. In particular, the operating system 315 may manage the data processing system's software and/or hardware resources and may coordinate execution of programs by the processor 300. The software update module 320 may be configured to facilitate updates to installed software on the data processing system. As discussed above, the types of updates made to the software on the data processing system are not limited and may be made in a variety of forms. The software image 325 may be any file or set of files and may even include the entire software image running on the data processing system. Moreover, the software image may include settings, such as network configuration information, printer information, and the like. The transition rules/data 330 may include rules/data for transitioning between compatibility classes of software versions. The rules may define what elements are added, what elements are removed, and/or what modifications are made to one or more of the elements when transitioning from one of the compatibility classes to another. This is illustrated, for example, in FIG. 4. In the example shown, the software may be a database file in which various fields may be included. There are three different compatibility classes having three different software versions associated therewith. In the first compatibility class/version, the database file includes a name and zip code. In the second compatibility class/version, the database file includes a name, zip code, and state. In the third compatibility class/version, the database file includes a name, zip code, and a state field that is indexed. Accordingly, the rule for transitioning from the first compatibility class/version to the second compatibility class/version is to add the state field. The rule for transitioning from the second compatibility class/version to the third compatibility class/version is to index the state field. The rule for transitioning from the third compatibility class/version to the second compatibility class/version is to do nothing as the second compatibility class/version merely includes a state field and does not require that the state field not be indexed. Finally, the rule for transitioning from the second compatibility class/version to the first compatibility class/version is to remove the state field.

In accordance with various embodiments of the present invention, rules may be defined for transitioning directly from a first class to a second class and/or indirectly in which rules are defined for transitioning from a first class to one or more intermediate classes and from transitioning from the one or more intermediate classes to a second class. In some embodiments, for example, a direct transition from a first class to a second class may not be allowed, but it may be possible to transition from the first class to a third class and then from the third class to the second class. In further embodiments, transition rules may be defined that specify invalid transitions between classes. These invalid transitions may define rollback fences to inform a software developer and/or administrator that if a transition is made to a certain class, it may not be possible to transition from that certain class to one or more other classes.

Although FIG. 3 illustrates exemplary hardware/software architectures that may be used in data processing systems, such as the development server 100 of FIG. 1 and/or the data processing system 200 of FIG. 2, for updating software based on transition rules between compatible versions, it will be understood that the present invention is not limited to such a configuration but is intended to encompass any configuration capable of carrying out operations described herein. Moreover, the functionality of the development server 100 of FIG. 1, the data processing system 200 of FIG. 2, and/or the hardware/software architecture of FIG. 3 may be implemented as a single processor system, a multi-processor system, or even a network of stand-alone computer systems, in accordance with various embodiments of the present invention.

Computer program code for carrying out operations of data processing systems discussed above with respect to FIGS. 1, 2, and 3 may be written in a high-level programming language, such as Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described herein with reference to flowchart and/or block diagram illustrations of methods, systems, and computer program products in accordance with exemplary embodiments of the invention. These flowchart and/or block diagrams further illustrate exemplary operations for updating software based on transition rules between compatible versions, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

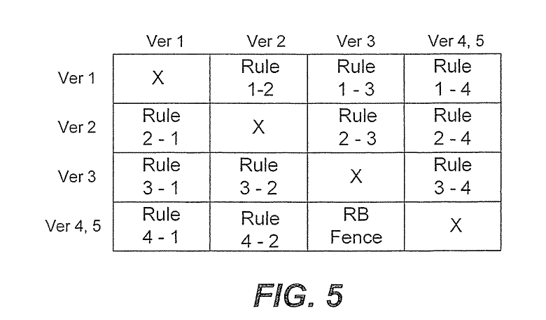

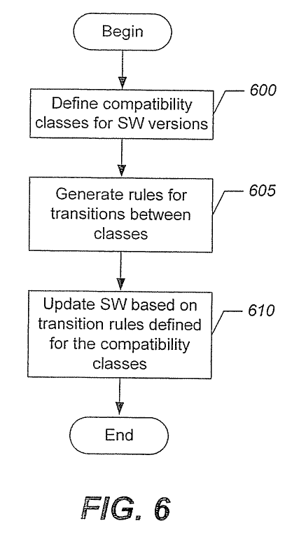

Referring now to FIG. 6, exemplary operations for updating software based on transition rules between compatible versions begin at block 600 where the software update module 320 is used to define compatibility classes for software versions. At block 605, the software update module 320 may be used to generate rules for transitions between compatibility classes. As shown in FIG. 5, the rules may be organized in the form of a matrix in which the various compatibility classes are used to define the rows and columns. In the FIG. 5 example, there are four compatibility classes with three compatibility classes having software versions 1-3 associated therewith and the fourth compatibility class having software versions 4 and 5 associated therewith. The rules for transitioning between one compatibility class to another may include a rule for transitioning directly between the compatibility classes and/or may include a combination of multiple rules involving the transition to one or more intermediate classes for transitioning to the final class (i.e., an indirect transition). In accordance with various embodiments of the present invention, a direct transition from a first class to a second class may be allowed, a direct transition from the first class to the second class may not be allowed, but an indirect transition by way of an intermediate class may be allowed between the first and second classes, or both a direct transition and an indirect transition may be allowed between the first and second classes. For an example of an indirect transition, the rule for transitioning from compatibility class 1 (version 1) to compatibility class 3 (version 3) may comprise a rule for transitioning from compatibility class 1 to compatibility class 2 (Rule 1-2) along with a rule for transitioning from compatibility class 2 to compatibility class 2 (Rule 2-3). Furthermore, as shown in FIG. 5, certain class transitions may be disallowed, such as the transition from compatibility class 4 to compatibility class 3. Such a disallowed transition may be termed a rollback fence and may provide a warning to a software developer or system administrator that a transition to a certain compatibility class may limit the potential options for transitioning out of that compatibility class.

Returning to FIG. 6, operations continue at block 610 where the software update module 320 updates one or more files, which may be represented as the software image 325 in FIG. 3. As discussed above, the updated files may be any file or set of files and may even include the entire software image running on the data processing system. In other embodiments, the updated files may include settings, such as network configuration information, printer information, and the like.

The flowchart of FIG. 6 illustrates the architecture, functionality, and operations of some embodiments of methods, systems, and computer program products for updating software based on transition rules between compatible versions. In this regard, each block represents a module, segment, or portion of code, which comprises one or more executable instructions for implementing the specified logical function(s). It should also be noted that in other implementations, the function(s) noted in the blocks may occur out of the order noted in FIG. 6. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

That which is claimed:

1. A method of updating software, comprising:
defining a plurality of compatibility classes for software versions;
generating rules for transitions between ones of the plurality of compatibility classes; and
updating software from a first one of the software versions to a second one of the software versions based on the rules.

2. The method of claim 1, wherein the first one of the software versions is in a first one of the plurality of compatibility classes and the second one of the software versions is in a second one of the compatibility classes; and
wherein the rules comprise at least one rule that disallows a transition from the second one of the plurality of compatibility classes to the first one of the plurality of compatibility classes.

3. The method of claim 1, wherein the first one of the software versions is in a first one of the plurality of compatibility classes and the second one of the software versions is in a second one of the compatibility classes; and
wherein updating the software comprises updating the software from the first one of the software versions to the second one of the software versions based on at least a first one of the rules for transitioning directly from the first one of the plurality of compatibility classes to the second one of the plurality of compatibility classes.

4. The method of claim 3, wherein the rules comprise a second one of the rules that disallows a transition directly from the second one of the plurality of compatibility classes to the first one of the plurality of compatibility classes.

5. The method of claim 3, wherein the rules comprise a second one of the rules for transitioning from the first one of the plurality of compatibility classes to a third one of the plurality of compatibility classes and a third one of the rules for transitioning from the third one of the plurality of compatibility classes to the second one of the plurality of compatibility classes.

6. The method of claim 5, wherein the rules comprise a fourth one of the rules that disallows a transition from the second one of the plurality of compatibility classes to the third one of the plurality of compatibility classes or a transition from the third one of the plurality of compatibility classes to the first one of the plurality of compatibility classes.

7. The method of claim 1, wherein the first one of the software versions is in a first one of the plurality of compatibility classes and the second one of the software versions is in a second one of the plurality of compatibility classes; and
wherein updating the software comprises updating the software from the first one of the software versions to the second one of the software versions based on at least a first one of the rules for transitioning from the first one of the plurality of compatibility classes to a third one of the plurality of compatibility classes and a second one of the rules for transitioning from the third one of the plurality of compatibility classes to the second one of the plurality of compatibility classes.

8. The method of claim 7, wherein the rules comprise a third one of the rules for transitioning directly from the first one of the plurality of compatibility classes to the second one of the plurality of compatibility classes.

9. The method of claim 7, wherein the rules comprise a third one of the rules that disallows a transition from the second one of the plurality of compatibility classes to the third one of the plurality of compatibility classes or a transition from the third one of the plurality of compatibility classes to the first one of the plurality of compatibility classes.

10. The method of claim 7, wherein the rules comprise a third one of the rules that disallows a transition directly from the second one of the plurality of compatibility classes to the first one of the plurality of compatibility classes.

11. The method of claim 7, wherein the rules comprise a third one of the rules that disallows a transition directly from the first one of the plurality of compatibility classes to the second one of the plurality of compatibility classes.

12. The method of claim 1, wherein one of the compatibility classes has a plurality of the software versions associated therewith.

13. The method of claim 1, wherein one of the compatibility classes has only one of the software versions associated therewith.

14. A system for updating software, comprising:
a data processing system that is configured to define a plurality of compatibility classes for software versions, generate rules for transitions between ones of the plurality of compatibility classes, and update software from a first one of the software versions to a second one of the software versions based on the rules.

15. The system of claim 14, wherein the first one of the software versions is in a first one of the plurality of compatibility classes and the second one of the software versions is in a second one of the compatibility classes; and
wherein the rules comprise at least one rule that disallows a transition from the second one of the plurality of compatibility classes to the first one of the plurality of compatibility classes.

16. The system of claim 14, wherein the first one of the software versions is in a first one of the plurality of compatibility classes and the second one of the software versions is in a second one of the compatibility classes; and
wherein the data processing system is further configured to update the software from the first one of the software versions to the second one of the software versions based on at least a first one of the rules for transitioning directly from the first one of the plurality of compatibility classes to the second one of the plurality of compatibility classes.

17. The system of claim 16, wherein the rules comprise a second one of the rules that disallows a transition directly from the second one of the plurality of compatibility classes to the first one of the plurality of compatibility classes.

18. The system of claim 14, wherein the first one of the software versions is in a first one of the plurality of compatibility classes and the second one of the software versions is in a second one of the plurality of compatibility classes; and
wherein the data processing system is further configured to update the software from the first one of the software versions to the second one of the software versions based on at least a first one of the rules for transitioning from the first one of the plurality of compatibility classes to a third one of the plurality of compatibility classes and a second one of the rules for transitioning from the third one of the plurality of compatibility classes to the second one of the plurality of compatibility classes.

19. The system of claim 18, wherein the rules comprise a third one of the rules that disallows a transition from the second one of the plurality of compatibility classes to the third one of the plurality of compatibility classes or a transition from the third one of the plurality of compatibility classes to the first one of the plurality of compatibility classes.

20. The system of claim 18, wherein the rules comprise a third one of the rules that disallows a transition directly from the first one of the plurality of compatibility classes to the second one of the plurality of compatibility classes.

21. A computer program product for managing software versions on a data processing system, comprising:
a computer readable storage medium having computer readable program code embodied therein, the computer readable program code comprising:
a data structure that comprises rules for transitions between ones of a plurality of compatibility classes for software versions.

22. The computer program product of claim 21, wherein one of the compatibility classes has a plurality of the software versions associated therewith.

23. The computer program product of claim 21, wherein one of the compatibility classes has only one of the software versions associated therewith.

24. A computer program product for updating software, comprising:
a computer readable storage medium having computer readable program code embodied therein, the computer readable program code comprising:
computer readable program code configured to define a plurality of compatibility classes for software versions;
computer readable program code configured to generate rules for transitions between ones of the plurality of compatibility classes; and
computer readable program code configured to update software from a first one of the software versions to a second one of the software versions based on the rules.

25. The computer program product of claim 24, wherein the first one of the software versions is in a first one of the plurality of compatibility classes and the second one of the software versions is in a second one of the compatibility classes; and
wherein the rules comprise at least one rule that disallows a transition from the second one of the plurality of compatibility classes to the first one of the plurality of compatibility classes.
